(19) United States
(12) Patent Application Publication
(10) Pub. No.: US 2026/0199904 A1
(43) Pub. Date: Jul. 16, 2026

(54) BLOW-BAR LOCKING SYSTEM METHOD AND DEVICE

(71) Applicant: Gerald Bauer, Rockford, IL (US)

(72) Inventor: Gerald Bauer, Rockford, IL (US)

(73) Assignee: Ekstrom Carlson Fabricating Co., Rockford, IL (US)

(21) Appl. No.: 19/416,180

(22) Filed: Dec. 11, 2025

Related U.S. Application Data
(60) Provisional application No. 63/744,530, filed on Jan. 13, 2025.

(51) Int. Cl. B02C 13/06; B02C 13/28

(52) U.S. Cl. CPC B02C 13/06; B02C 13/2804

(57) ABSTRACT

A method of retrofit for a blow-bar locking system of a first configuration in a horizontal shaft impactor machine. The method includes the steps of removing the blow-bar locking system of the first configuration and replacing it with a blow-bar locking system of significantly fewer and less complex parts.

### CROSS-REFERENCE TO RELATED PATENT APPLICATION

This patent application claims the benefit of U.S. Provisional Patent Application No. 63/744,530, filed Jan. 13, 2025. The entire teachings and disclosures are incorporated herein by reference thereto.

### FIELD OF THE INVENTION

This invention generally relates to horizontal shaft impact crushers and more specifically to blow-bar locking systems and methods therefore.

### BACKGROUND OF THE INVENTION

Horizontal shaft impact crushers also referred to as horizontal shaft impactor machines break rock or other similar material that may be crushed by impacting the rock with blow-bars, also referred to as hammers, that are fixed upon the outer edge of a spinning rotor shaft. PRIOR ART FIG. 4 illustrates a prior art horizontal shaft impact machine 600. FIG. 5 illustrates a partial exploded view of a horizontal shaft assembly 602 and blow-bar locking system 604. The horizontal shaft assembly 602 includes a horizonal shaft 606 having ribs 608, 610, 612, 614 spaced apart from one another and extending around the horizontal shaft 606. Each rib 608, 610, 612, 614 defines a notch 616 in a radially outermost surface of the rib 608, 610, 612, 614. The notch 616 defines an innermost surface comprising a first notch surface 618 opposite a second notch surface 620. A bottom surface 622 extends from the first notch surface 618 to the second notch surface 620.

The horizontal shaft assembly 602 includes guide rod 623 seated in a groove 624 in the first notch surface 618. A blow-bar 626 defines a longitudinally extending channel 628 extending along a face 630 of the blow-bar 626. The guide rod 623 is received into the longitudinally extending channel 628 mounting and removably fixing the blow-bar 626 in the notch 616. A portion of the blow-bar 626 is sandwiched between the guide rod 623 and the blow-bar locking system 604 to removably fix the blow-bar 626 to the ribs 608, 610, 612, 614. By removably fixed, it is meant that because the blow-bar 626 wears with use, it is periodically removed and repaired or entirely replaced with a new blow-bar.

The blow-bar locking system 604 includes an upper wedge 632, a first shim plate 634, and a second shim plate 636. The shims 634, 636 are positioned between a blow-bar facing face 638 of the upper wedge 632 and bear against the guide rod 623 when installed in in each notch 616 of the ribs 608, 610, 612, 614. Once inserted in the notch 616, the upper wedge 632 is seated on a tapered upper surface 640 of a lower wedge 642. A bracket 644 bracketing the lower wedge 642 is joined thereto via a threaded fastener 646 extending through the lower wedge 642 and secured with a nut 648. The threads of the threaded fastener 646 extend substantially the length of the shaft of the threaded fastener 646. The blow-bar locking system 604 is positioned in each notch 616 of each rib 608, 610, 612, 614 to removably fix the blow-bar 626 against each rib 608, 610, 612, 614.

Still with respect to FIGS. 4 and 5, the working environment of the horizontal shaft impact machine 600 is harsh with the crushed rock filling the threads of the threaded fastener 646 and the nut 648. This coupled with exposure to moisture leads to corrosion. The corrosion makes it difficult to remove the blow-bar locking system 604 for removal of the blow-bar 626 for repair or replacement. Often, due to the corrosion, the nut 648 must be cut off to permit the threaded fastener 646 to be removed and thereafter the blow-bar locking system 604 can be removed and thereafter the blow-bar 626. In addition to the foregoing, the horizontal impact machine 600 comprises multiple parts that make it complex to put into position in the notch 616 and thereafter adjust with the threaded fastener 646 and nut 648, particularly as the threads become corroded and notch 616 fills with the crushed rock along with the upper wedge 632, lower wedge 642, and bracket 644.

With respect to FIG. 5, to replace or repair the blow-bar 626, the threaded fastener 646 is turned to permit the upper wedge 632 to slide down along the tapered upper surface 640 of the lower wedge 642 and thereby lessen the force of the upper wedge 632 pushing against the blow-bar 626. Often, due to the corrosion, the nut 648 must be cut off to permit the threaded fastener 646 to be removed and thereafter the blow-bar locking system 604 can be removed. More specifically, after the nut 648 and the threaded fastener 646 are removed, the remaining pieces of the blow-bar locking system 604 are removed, that is, the upper wedge 632, the first shim plate 634 and the second shim plate 636, the bracket 644, and the lower wedge 642 are removed from the notch 616 of each rib 608, 610, 612, 614. At this point, the blow-bar 626 is removed for repair or replacement.

### BRIEF SUMMARY OF THE INVENTION

The invention provides a replacement part and method comprising a blow-bar locking system configuration that reduces the time, labor, and material necessary to replace an existing blow-bar locking system of a second configuration in a horizontal shaft impact crushing machine. These and other advantages of the invention, as well as additional inventive features, will be apparent from the description of the invention provided herein.

The method includes the steps of removing the blow-bar locking system of the first configuration. The first configuration includes an upper wedge and a lower wedge. The method includes the steps of installing a blow-bar locking system of a second configuration. The second configuration includes a quick release wedge, a fastener, and a nut.

In an embodiment, the quick release wedge includes a wedge body, the wedge body includes a top side, a bottom side opposite the top side, a first side, a second side opposite the first side, a front side, and a back side opposite the front side, the back side and the front side extending from the top side to the bottom side and from the first side to the second side. The backside converges towards the top side to define a tapered plane. The front side extends normal to the bottom side. A through-hole entirely free of threads extends through the wedge body from the bottom side through the top side. The bottom side defines a counter-bore surrounding the through-hole.

In an embodiment, the method includes inserting a threaded end of the fastener through the through-hole at the top side until it extends through the through-hole at the bottom side. The method includes the steps of threading a nut onto the threaded end until the nut is fully received and seated in the counterbore. The planar innermost surfaces of the counterbore abut at least partially planar outermost surfaces of the nut to stop the nut from rotating about the threaded end.

In an embodiment, the method includes the step of inserting the quick release wedge into the notch. The second notch surface is received into the rib channel on the backside of the wedge body and the first side of the wedge body abuts the blow-bar.

In an embodiment, the method includes the step of rotating a head end of the fastener in a first rotational direction to move the fastener in a first linear direction to abut an end face of the threaded end of the fastener against the bottom surface of the notch.

In an embodiment, the method incudes the step of rotating the head end of the fastener to move the fastener in the first direction and the wedge body in a second linear direction opposite the first linear direction to removably fix the blow-bar in the notch.

In an embodiment, the method includes the step of rotating the head end of the fastener in a second rotational direction, opposite the first rotational direction to move the fastener in the second linear direction and the wedge body in the first linear direction so as to remove the wedge body from the notch.

In an embodiment, the step of removing further includes removing the blow-bar locking system of the first configuration. The first configuration includes a shim assembly, a bracket bracketing the lower wedge, a threaded fastener surrounded by threads in an internal bore of the lower wedge.

In an embodiment, the method includes the step of inserting a tool into or around the head end of the fastener to rotate the fastener.

In an embodiment, the method includes the step of abutting opposed channel walls of the channel against radially opposed outermost sides of the rib. The second notch surface extends between the opposed outermost sides of the rib.

In another aspect, the invention provides a replacement part for a blow-bar locking system of a horizontal shaft impactor machine. The horizontal shaft impactor machine includes ribs spaced apart from one another and extending around the horizontal shaft. Each rib defines a notch in a radially outermost surface of the rib. The notch includes a guide rod in a first side of the notch opposite a second side of the notch. A blow-bar defines a longitudinally extending channel extending along a face of the blow-bar. The guide rod is received into the longitudinally extending channel to mount the blow-bar. The blow-bar is removingly fixed within the notch by the blow-bar locking system. The blow-bar locking system includes a plurality of components comprising an upper wedge and a lower wedge. The replacement part includes a wedge body that includes a top side, a bottom side opposite the top side, a first side, a second side opposite the first side, a front side, and a back side opposite the front side. The back side and the front side extend from the top side to the bottom side and from the first side to the second side. The back side converges toward the top side to define a tapered plane. The front side extends normal to the bottom side. A through-hole free of threads extends through the bottom side and the top side. The bottom side defines a counterbore surrounding the through-hole.

In an embodiment, the back side defines a channel recessed into a radial outermost surface of the back side, the channel extending from the bottom surface to the top surface.

In an embodiment, the channel is sized to receive the second side of the notch to seat the wedge body within the notch.

In an embodiment, the counterbore is sized to receive a nut having radially outmost planar surfaces. The nut acts on a stop to prevent rotation of a threaded end of a fastener extending from the top side to the bottom side of the wedge body when mounted in the notch.

In an embodiment, the fastener has a head end opposite the threaded end. The head end has an engagement portion permitting rotation of the fastener.

In an embodiment, the head end is a cap sized to receive a tool therein to rotate the fastener.

In an embodiment, the wedge body is sized to sandwich the blow-bar between the front side of the wedge body and the guide rod in the blow-bar to removably fix the blow-bar in the notch.

In an embodiment, the wedge body is sized to be sandwiched between the first side of the notch and the blow-bar to removably fix the blow-bar in the notch.

In an embodiment, the first side of the notch is received into the channel of the back side of the wedge body to removably fix the blow-bar in the notch.

In an embodiment, rotation of the head end in a first rotational direction rotates the fastener to engage an end face of the fastener against a bottom surface of the notch and moves the wedge body in a first direction extending parallel to a longitudinal axis of the wedge body to removably fix the wedge body in the notch against the blow-bar.

In an embodiment, rotation of the head end in a second direction opposite the first direction allows the wedge body to move in a second direction opposite the first direction to remove the wedge body from the notch.

Other aspects, objectives, and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a partial assembly view of a blow-bar locking system according to the teachings of the instant invention;

FIG. 2 illustrates a bottom view of a quick release wedge of the blow-bar locking system of FIG. 1;

FIG. 3 is a partial side view of the blow-bar locking system of FIG. 1;

FIG. 4 and is a PRIOR ART horizontal shaft impact machine; and

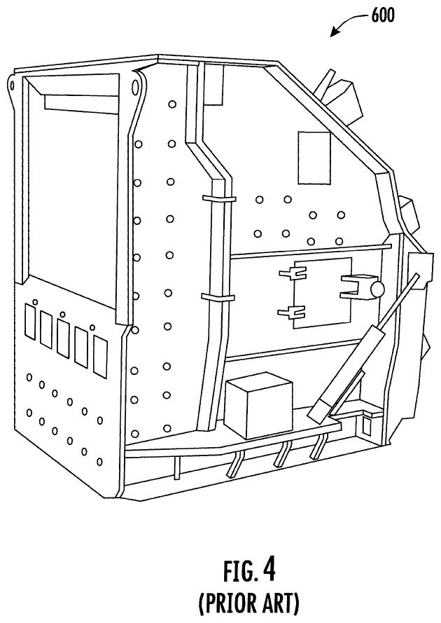

FIG. 5 is a partial assembly view of a PRIOR ART blow-bar locking system found in the PRIOR ART horizontal shaft impact machine of FIG. 4.

While the invention will be described in connection with certain preferred embodiments, there is no intent to limit it to those embodiments. On the contrary, the intent is to cover all alternatives, modifications, and equivalents as included within the spirit and scope of the invention as defined by the appended claims.

### DETAILED DESCRIPTION OF THE INVENTION

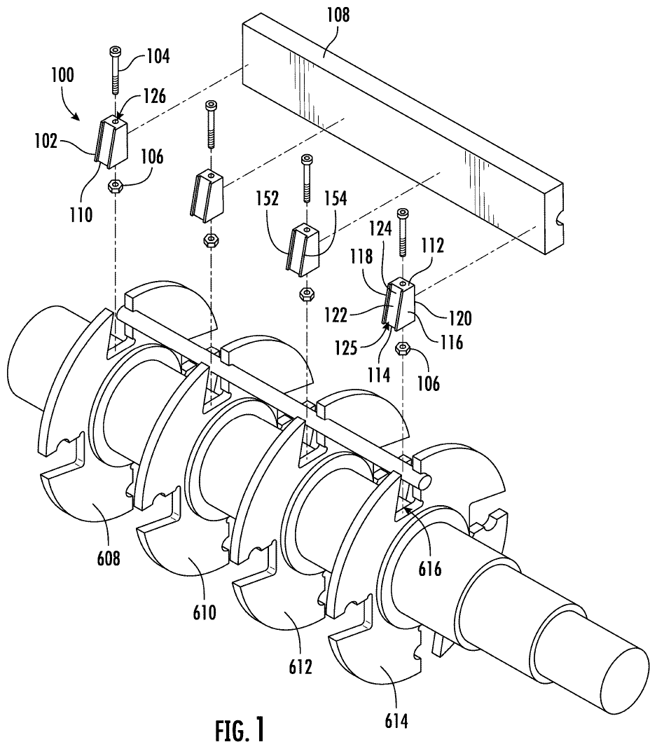

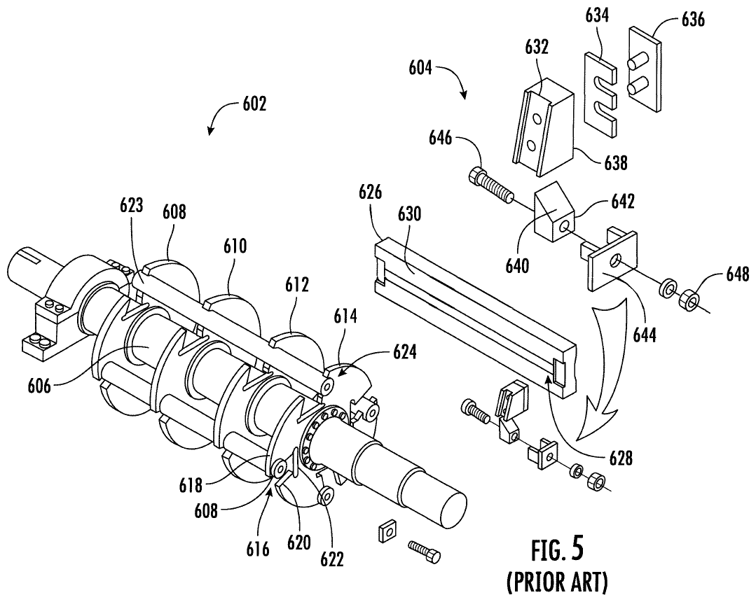

As noted above, with respect to FIG. 5, the blow-bar 626 wears with use and must be periodically removed and repaired or entirely replaced. In the method according to the teachings of the instant application, the blow-bar 626 is replaced and a new blow-bar locking system 100, FIG. 1 is installed instead of the blow-bar locking system 604 (FIG. 5). The new blow-bar locking system 100 (FIG. 1) is much less complicated than the blow-bar locking system 604 (FIG. 5). Indeed, as seen in FIG. 1, it uses less parts, that is, it only uses a quick release wedge 102, a bolt 104 and a nut 106. The fewer number of parts also means there are less parts that become corroded. Because there are less parts that can become corroded, then removal of the blow-bar locking system 100 is much simpler requiring less tools, time, and labor than it takes to remove the blow-bar locking system 604 (FIG. 5).

FIG. 1 illustrates the repaired or new blow-bar 108 before insertion into each of the ribs 608, 610, 612, 614. Once a new or repaired blow-bar 108 is inserted, then a new blow-bar locking system 100 is installed in each notch 616 to fix the blow-bar 108 against the ribs 608, 610, 612, 614.

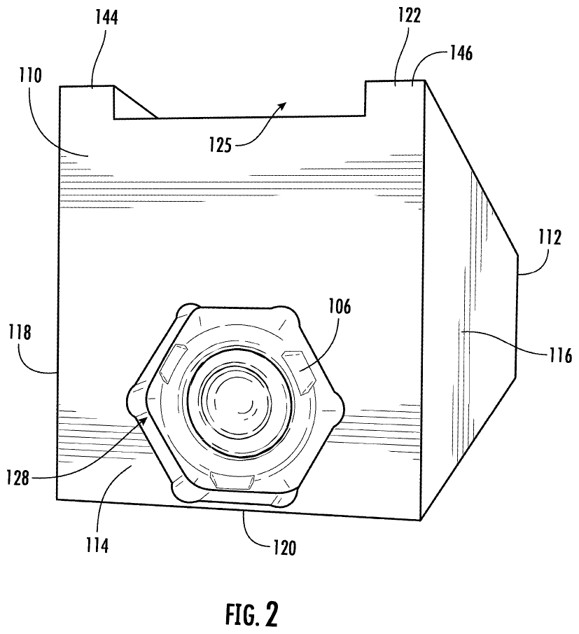

The new blow-bar locking system 100 includes the quick release wedge 102. The quick release wedge 102 defines a wedge body 110. With respect to FIG. 1. and FIG. 2, the wedge body 110 includes a top side 112 and a bottom side 114 opposite the top side 112. A first side 116 is opposite a second side 118. A front side 120 is opposite a back side 122. The back side 122 and the front side 120 each extend from the top side 112 to the bottom side 114 and from the first side 116 to the second side 118. The back side 122 converges from the bottom side 114 towards the top side 112 to define a tapered plane 124. The back side 122 defines a rib channel 125 extending the entire length of the quick release wedge 102. The front side 120 extends normal to the bottom side 114 and the top side 112.

A through-hole 126 (FIG. 1) entirely free of threads extends through the wedge body 110 from the bottom side 114 through the top side 112. The through-hole 126 is a feature permitting a quick release wedge 102 as the quick release can be understood as there being no threads surrounding the inner diameter of the through-hole 126. Therefore, once unthreaded from the nut 106, then the bolt 104 is free to easily slide out of the through-hole 126 without having to be further rotationally turned to unthread the bolt from the through-hole 126.

The bottom side 114 defines a counterbore 128 (FIG. 2) surrounding the through-hole 126. The counterbore 128 receives the nut 106 and acts as a stop that prevents rotation of the nut 106 once the bolt 104 is threaded therethrough such that the nut 106 is not free to drop out of the counterbore 128.

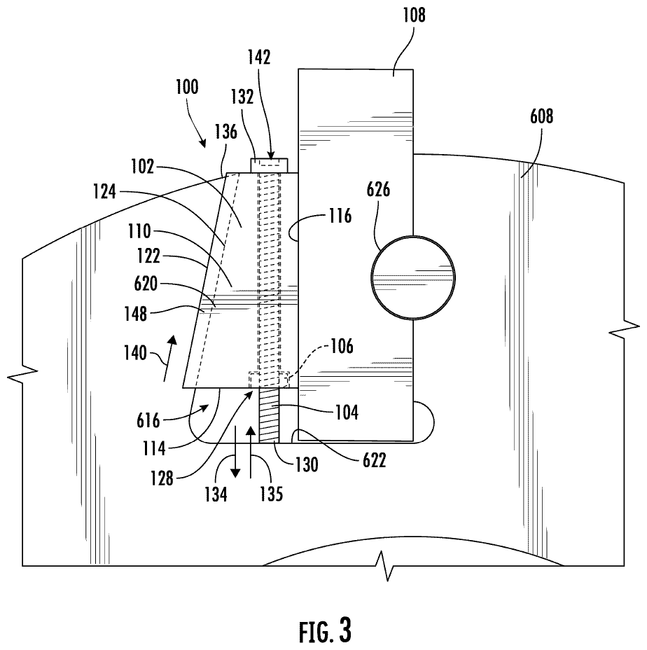

Accordingly, before insertion of the new blow-bar locking 100 in the notch 616, the bolt 104 is inserted through the through-hole 126 of the quick release wedge 102. The nut 106 is threaded onto the end 130 of the bolt 106 opposite a head 132 of the bolt 104 until it is seated in the counterbore 128 and is not able to fall out of the counterbore 128 (FIG. 3). In this seated position, planar innermost surfaces of the counterbore 128 (FIG. 2) abut at least partially planar outermost surfaces of the nut 106 (FIG. 2) to stop the nut 106 from rotating while the bolt 104 is threaded through the nut 106.

Turning now to FIG. 3, the head 132 of the bolt 104 is rotated moving the bolt 104 in a first linear direction 134 until the end 130 opposite the head 132 bears against the second notch surface 620. It should be apparent that when the bolt 104 abuts the second notch surface 620, it no longer is free to move in the first linear direction 134. Because the nut 106 cannot turn in this position, then rotation of the bolt 104 creates linear movement of the quick release wedge 102 to allow it to move in a second direction 135 toward the outermost radial surface 136 of the rib 608 creating a force against the blow-bar 626 to keep the blow-bar 626 in fixed in position in the notch 616.

In the notch 616, the second notch surface 620 is received into the rib channel 125 (FIG. 1) such that the second notch surface is slidable along the tapered surface 124 of the quick release wedge 102 while the first side 116 of the wedge body 110 abuts and slides along a face of the blow-bar 626.

As noted above, rotating the head 132 of the bolt 104 in a first rotational direction moves the bolt 104 in the first linear direction 134 to abut the end 130 of the bolt 104 against the bottom surface 622 of the notch 616.

Once the end 130 bears against the bottom surface 622, further rotation of the head 132 of the bolt 104 in the first rotational direction moves the wedge body 110 in the second linear direction 135 opposite the first linear direction 134 to removably fix the blow-bar 626 in the notch 616. As noted previously, because of the tapered plane 124 of the back side 122 in the rib channel 125 (FIG. 1), the wedge body 110 is able to slide along the second notch surface 620 in directions 140 of the rib 608 to “lock” the wedge body 110 against the blow-bar 626 to removably fix it in place to withstand the crushing blows of the blow-bar 626 against the rocks it breaks up in operation.

Rotating the head 132 of the bolt 104 in a second rotational direction, opposite the first rotational direction moves the bolt 104 in the second linear direction 135 and thereby permitting the wedge body 110 to be moved in the first linear direction 134 so as to “unlock” the wedge body 100 and lessen the force of the wedge body 110 against the blow-bar 626 so as to allow it to slide down along its tapered plane 124 and ultimately freed to be slid out from the notch 616 thereby permit removal of the blow-bar 626. It should be understood at this point of the disclosure that the method is discussed with respect to only one notch 616 of one rib 608 and one new bar locking system 100. However, each remaining rib 610, 612, 614 receives its own new bar locking system 100 which is the same for each rib 610, 612, 614 as seen in FIG. 1.

The head 132 of the bolt 104 can have a recessed internal geometry 142 that is an engagement portion, for example a hex head or equivalent geometries, thereby permitting insertion of a tool into the head 132 of the bolt 104 to permit the bolt 104 to be rotated. A wrench or similar tool providing a torquing force can also be used around the outermost surface of the head 132 as well. As seen in FIG. 1, the rib channel 125 has opposed channel walls 152, 154 that are received and therefore abut against opposed outermost faces of the rib 608.

Also, at this point in the disclosure, it is readily apparent that the new blow-bar locking system 100 can be a replacement part for the blow-bar locking system 604 (see FIG. 5) such that use thereof allows for less parts, less labor, because the assembly is far more simple than the blow-bar locking system 604 while at the same time allowing for reliable force to lock the blow-bar 108 into position sandwiching the wedge body 110 (FIG. 3) between the rib 608 (FIG. 3) and the blow-bar 108 (FIG. 3) to withstand the impact of the blow-bar 108 (FIG. 3) against the rocks it is meant to break apart and crush.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of retrofit for a blow-bar locking system of a horizontal shaft impactor machine, the horizontal shaft impactor machine comprising a horizontal shaft assembly and blow-bar locking system of a first configuration, the horizontal shaft assembly comprising ribs spaced apart from one another and extending around a horizontal shaft, each rib defining a notch in a radially outermost surface of the rib, the notch defining innermost surfaces comprising a first notch surface opposite a second notch surface, a bottom surface extending from the first notch surface to the second notch surface, wherein a guide rod is seated in a groove in the first notch surface, wherein a blow-bar defines a longitudinally extending channel extending along a face of the blow-bar, the guide rod received into the longitudinally extending channel to mount and removably fix the blow-bar in the notch, a portion of the blow-bar sandwiched between the guide rod and the blow-bar locking system to removably fix the blow-bar to the rib, the method comprising the steps of:
removing the blow-bar locking system of the first configuration comprising:
an upper wedge and a lower wedge;
installing a blow-bar locking system of a second configuration, the second comprising:
a quick release wedge;
a fastener; and
a nut.

2. The method of claim 1, the quick release wedge comprising a wedge body, the wedge body comprising:
a top side;
a bottom side opposite the top side;
a first side;
a second side opposite the first side;
a front side;
a back side opposite the front side, the back side and the front side extending from the top side to the bottom side and from the first side to the second side;
the back side defining a rib channel; wherein the backside converges towards the top side to define a tapered plane, the front side extending normal to the bottom side;
a through-hole entirely free of threads extending through the wedge body from the bottom side through the top side; and
wherein the bottom side defines a counterbore surrounding the through-hole.

3. The method of claim 2, further comprising the step of:
inserting a threaded end of the fastener into through the through-hole at the top side until it extends through the through-hole at the bottom side;
threading the nut onto the threaded end until the nut is full received and seated in the counterbore,
wherein planar innermost surfaces of the counter bore abut at least partially planar outermost surfaces of the nut to stop the nut from rotating about the threaded end.

4. The method of claim 3, comprising the step of inserting the quick release wedge into the notch, the second notch surface is received into the rib channel on the back side of the wedge body and the first side of the wedge body abuts the blow-bar.

5. The method of claim 4, further comprising the step of rotating a head end of the fastener in a first rotational direction to move the fastener in a first linear direction to abut an end face of the threaded end of the fastener against the bottom surface of the notch.

6. The method of claim 5, comprising the step of rotating the head end of the fastener in the first rotational direction to move the wedge body in a second linear direction opposite the first linear direction to removably fix the blow-bar in the notch.

7. The method of claim 6, comprising the step of rotating the head end of the fastener in a second rotational direction, opposite the first rotational direction to move the fastener in the second linear direction and permit the wedge body to be moved in the first linear direction so as to remove the wedge body from the notch.

8. The method of claim 1, the removing step further comprises:
Removing a shim assembly, a bracket bracketing the lower wedge, a threaded fastener surrounded by threads in an internal bore of the lower wedge.

9. The method of claim 7, further comprising the step of inserting a tool into or around the head end of the fastener to rotate the fastener.

10. The method of claim 1, further comprising the step of abutting opposed channel walls of the channel against radially opposed outermost sides of the rib, the second notch surface extending between the opposed outermost sides of the rib.

11. A replacement part for a blow-bar locking system in a horizontal shaft impactor machine, the horizontal shaft impactor machine comprising a horizontal shaft assembly having ribs spaced apart from one another and extending around a horizontal shaft, each rib defining a notch in a radially outermost surface of the rib, the notch comprising a guide rod in a first side of the notch and a tapered surface on a second side of the notch opposite the first side of the notch, a blow-bar is partially received in the notch, the blow bar defining a longitudinally extending channel extending along a face of the blow-bar, the guide rod seated in the longitudinally extending channel of the blow-bar to mount the blow-bar in the notch, the blow-bar being removingly fixed within the notch by the blow-bar locking system of the first configuration, the blow-bar locking system comprising an upper wedge, a lower wedge a first shim plate, a second shim plate and a bracket; the replacement part for the blow bar locking system comprising:
a quick release wedge defining a wedge body comprising:
a top side;
a bottom side opposite the top side;
a first side;
a second side opposite the first side;
a front side;
a back side opposite the front side, the back side and the front side extending from the top side to the bottom side and from the first side to the second side, wherein the backside converges toward to top side to define a tapered plane, the front side extending normal to the bottom side;
a through-hole free of threads extending through the bottom side and the top side; and
wherein the bottom side defines a counterbore surrounding the through-hole.
a fastener extending through the through-hole; and
a nut seated in the counterbore and threaded on the fastener.

12. The replacement part of claim 11, wherein the back side defines a channel recessed into a radial outermost surface of the back side, the channel extending from the bottom surface to the top surface.

13. The replacement part of claim 11, the nut having radially outermost planar surfaces, the nut acting a stop to prevent rotation of a threaded end of fastener extending through the through-hole when mounted in the notch.

14. The replacement part of claim 13, wherein the fastener has a head end opposite the threaded end, the head end having an engagement portion permitting rotation of the fastener.

15. The replacement part of claim 14, wherein the head end is a cap sized to receive a tool therein to rotate the fastener.

16. The replacement part of claim 11, wherein the wedge body is sized to sandwich the blow-bar between the frond side of the wedge body and the guide rod in the blow-bar to removably fix the blow-bar in the notch.

17. The replacement part of claim 1, wherein the wedge body is sized to be sandwiched between the first side of the notch and the blow-bar to removably fix the blow-bar in the notch.

18. The replacement part of claim 17, wherein the first side of the notch is received into the channel of back side of the wedge body to removably fix the blow-bar in the notch.

19. The replacement part of claim 15, wherein rotation of the head end in a first rotational direction rotates the fastener to engage an end face of the fastener against a bottom surface of the notch and move the wedge body in a linear direction to removably fix the wedge body in the notch against the blow-bar.

20. The replacement part of claim 15, wherein rotation of the head end in a second rotational direction opposite the first rotational direction allows the wedge body to move in a second direction opposite the first direction to remove the wedge body from the notch.
